(19) United States
(12) Patent Application Publication
(10) Pub. No.: US 2026/0326023 A1
(43) Pub. Date: Oct. 22, 2026

(54) SPIRAL MESH ROTATING BED ABSORBER FOR COMPACT CARBON CAPTURE

(71) Applicant: NUOVO PIGNONE TECNOLOGIE - S.R.L., Florence (IT)

(72) Inventors: Brian REEVES, Edmond, OK (US); Robert KRUMM, Edmond, OK (US); Jose Adrian CHAVEZ VELASCO, Jalisco (MX)

(21) Appl. No.: 19/105,601

(22) PCT Filed: Aug. 25, 2023
(86) PCT No.: PCT/EP2023/025387

§ 371 Date: Feb. 21, 2025

Related U.S. Application Data
(60) Provisional application No. 63/402,099, filed on Aug. 30, 2022.

(51) Int. Cl. B01D 53/18; B01D 53/14

(52) U.S. Cl. CPC B01D 53/18; B01D 53/1425; B01D 53/1475; B01D 53/1493; B01D 2252/20484; B01D 2252/20489; B01D 2252/60; B01D 2257/504

(57) ABSTRACT

A carbon capture system configured to remove carbon dioxide from a carbon-containing feed stream includes a rotating bed absorber that that includes a spiral rotating contactor inside a tank that is at least partially filled with a liquid solvent or absorbent. The spiral rotating contactor includes one or more spiral flights that extend outward from a central hub. The rotating bed absorber is configured to produce clean gas with a reduced carbon dioxide concentration and loaded solvent from the feed stream. The carbon capture system further can optionally include a regenerator downstream from the rotating bed absorber for regenerating the liquid absorbent.

### RELATED APPLICATIONS

This application claims the benefit of U.S. Provisional Patent Application Ser. No. 63/402,099 filed Aug. 30, 2022 entitled, “Spiral Mesh Rotating Bed Absorber for Compact Carbon Capture,” the disclosure of which is herein incorporated by reference.

### FIELD OF THE INVENTION

This invention relates generally to carbon capture systems, and more particularly, but not by way of limitation, to an improved system for contacting a carbon-containing feed stream with a suitable carbon capture solvent.

### BACKGROUND

Carbon dioxide is the primary greenhouse gas emitted by human activities. In 2020, carbon dioxide accounted for about 79% of all human-based greenhouse gas emissions in the United States. Although there are a variety of carbon dioxide mitigation techniques, the use of liquid solvents and absorbents has been widely adopted. Amine-based solvents like monoethanolamine (MEA) have been found to be particularly effective at capturing carbon dioxide.

In many cases, carbon capture absorbents are fed into a contactor tower in a countercurrent flow with a carbon-containing feed stream. Packing materials can be loaded into beds, which increase the contact area between the carbon-containing stream and the absorbent. The absorbents pull the carbon out of the feed gases before the gases are released from the tower. The loaded absorbents are carried from the contactor tower to a regeneration system, which separates the carbon-based components from the absorbent. The regenerated absorbent can then be returned to the contactor tower in a cyclic process.

Although these measures have enjoyed some success, there remains a need for an improved system and process for contacting a carbon-based feed stream with a suitable absorbent. The present disclosure is directed to these and other deficiencies in the prior art.

### SUMMARY OF THE INVENTION

In one aspect, the present disclosure is directed to a carbon capture system configured to remove carbon dioxide from a carbon-containing feed stream, such as a post-combustion gas feed stream. The carbon capture system includes a rotating bed absorber that includes a spiral rotating contactor. The rotating bed absorber is configured to produce clean gas with a reduced carbon dioxide concentration and loaded solvent from the feed stream. The post-combustion carbon capture system further includes a regenerator downstream from the rotating bed absorber.

In another embodiment, the present disclosure is directed to a carbon capture system configured to remove carbon dioxide from a carbon-containing feed stream where the carbon capture system includes a rotating bed absorber and a regeneration module. The rotating bed absorber has a tank that includes a liquid absorbent, a motor, and a spiral rotating contactor inside the tank. The spiral rotating contactor includes a central hub, one or more spiral flights extending away from the central hub, and a rotatable shaft connected to the central hub and driven by the motor.

In other embodiments, the present disclosure is directed to a carbon capture system configured to remove carbon dioxide from a carbon-containing feed stream. The carbon capture system has a rotating bed absorber that includes a tank that is at least partially filled with a liquid absorbent and a spiral rotating contactor inside the tank. The spiral rotating contactor includes a central hub, one or more spiral flights extending away from the central hub, and a rotatable shaft connected to the central hub and driven by the motor. The rotating bed absorber further includes a discharge port connected to the tank and configured to remove a rich absorbent discharge stream from the rotating bed absorber, and an upper port connected to the tank and configured to remove a carbon-reduced gas stream from the rotating bed absorber and admit a lean solvent input stream into the tank. The carbon capture system can also include a regeneration module that is configured to regenerate the liquid absorbent by heating the rich absorbent discharge stream to produce a hot lean solvent stream and a hot gas stream.

### BRIEF DESCRIPTION OF THE DRAWINGS

FIG. 1 is a process flow diagram for a carbon capture process for removing carbon dioxide from a carbon-containing feed stream.

FIG. 2 is a perspective, partial cross-sectional view of a compact rotating bed absorber constructed in accordance with a first embodiment.

FIG. 3 is a top, partial cross-sectional view of the compact rotating bed absorber of FIG. 2.

FIG. 4 is a cross-sectional depiction of a portion of the spiral mesh element within the compact rotating bed absorber of FIGS. 2 and 3.

FIG. 5 is a perspective view of the central hub of the compact rotating bed absorber of FIGS. 2 and 3.

FIG. 6 is a perspective, partial cross-sectional view of a compact rotating bed absorber constructed in accordance with a second embodiment.

### WRITTEN DESCRIPTION

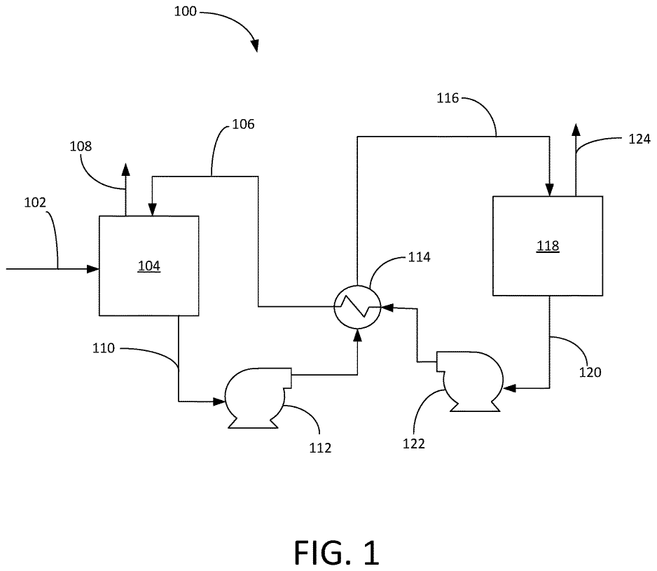

FIG. 1 is a process flow diagram that depicts a carbon capture system 100 that is designed to remove carbon dioxide (CO₂) from a carbon-containing feed stream 102. Although the feed stream 102 is typically a flue gas or other post-combustion stream, the feed stream 102 can also originate from open sources that collect carbon dioxide. The feed stream 102 is carried to a rotating bed absorber 104, where it mixes with a solvent injected from a lean solvent input stream 106. Clean gas with a reduced concentration of CO₂ is discharged in a gas discharge stream 108.

In some embodiments, the solvent is an amine-based solvent. Suitable solvents include mixtures of water with monoethanolamine (MEA), diethanolamine (DEA), triethanolamine (TEA) or potash. Within this disclosure, the terms solvent, carbon capture solvent, absorbent, and carbon capture absorbent are used interchangeably. The loaded solvent is discharged from the rotating bed absorber 104 through a rich absorbent discharge stream 110. The rich absorbent discharge stream 110 is pressurized with a first pump 112 and passed through a heat exchanger 114, where it is heated and discharged as hot rich absorbent stream 116.

The hot rich absorbent stream 116 is fed to a regeneration module 118, which may be configured as a rotating bed or a conventional stripper tower. The regeneration module 118 heats the loaded solvent to release the carbon dioxide from the solvent. The stripped “lean” solvent is carried out of the regeneration module 118 in a hot lean absorbent stream 120. The hot lean absorbent stream 120 passes through a second pump 122 and the heat exchanger 114, where it transfers heat to the incoming rich absorbent discharge stream 110 and becomes the lean solvent input stream 106. The released carbon dioxide gas is carried in a hot gas stream 124 out of the regeneration module 118.

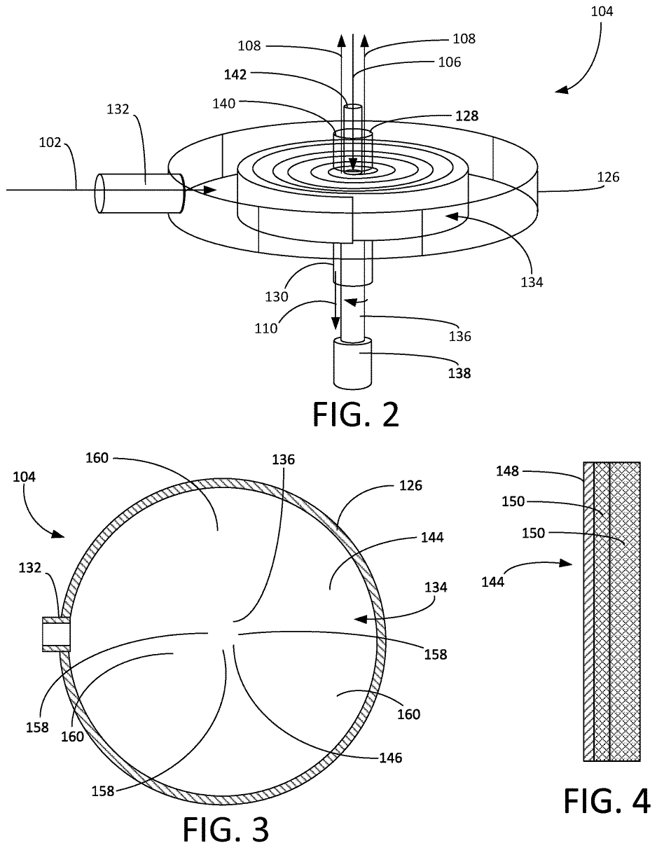

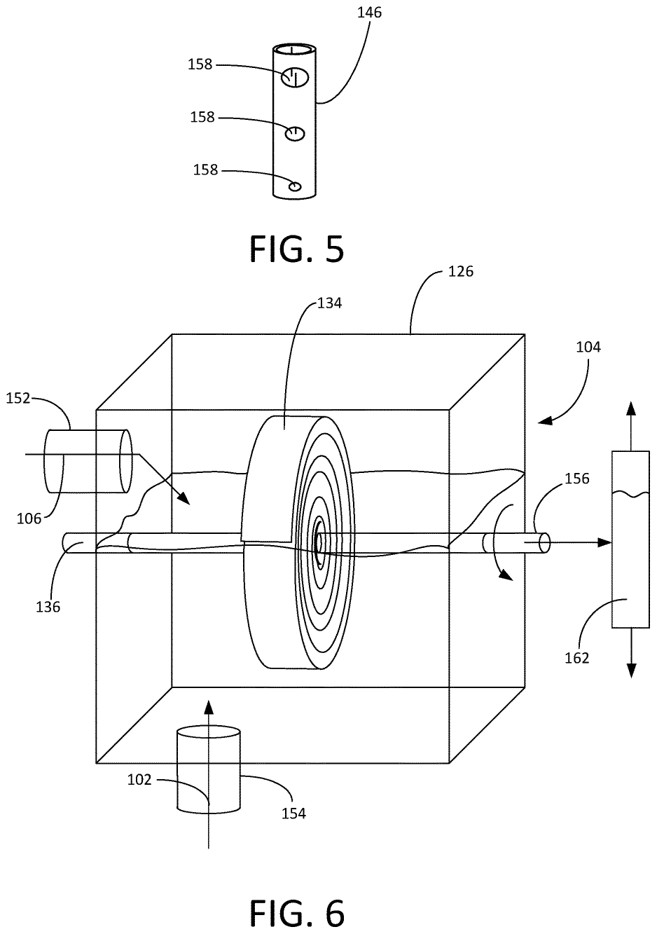

Turning to FIG. 2, shown therein is a depiction of a first embodiment of the rotating bed absorber 104. In this embodiment, the rotating bed absorber 104 includes a tank 126 with an upper port 128, a lower discharge port 130 and a gas intake port 132. The tank 126 can be configured as a cylindrical tank (as shown), a canonical tank, or any other form that suitably matches the rotating bed absorber 104. The gas intake port 132 can be placed in the side of the tank 126 (as shown), in the top of the tank 126, or in the bottom of the tank 126. The rotating bed absorber 104 can include multiple gas intake ports 132. In each case, the gas intake port 132 is configured to accept the feed stream 102 of a carbon-containing fluid.

The rotating bed absorber 104 includes a spiral rotating contactor 134 inside the tank 126. The spiral rotating contactor 134 is connected to a shaft 136 that is driven by a motor 138. The shaft 136 can be made coaxial with the lower discharge port 130 such that the shaft 136 passes through the interior of the lower discharge port 130. In other embodiments, the shaft 136 and lower discharge port 130 are not coaxial and the shaft 136 and lower discharge port 130 connect to different locations on the tank 126. As depicted in FIG. 2, the lower discharge port 130 can be connected to the lower portion of the tank 126 and configured to carry the rich absorbent discharge stream 110 away from the rotating bed absorber 104 through an annular space surrounding the internal coaxial shaft 136.

The upper port 128 extends through the upper portion of the tank 126. In the embodiment depicted in FIG. 2, the upper port 128 is positioned in a central location proximate the top of the spiral rotating contactor 134. The upper port 128 can be stationary or configured for rotation with the spiral rotating contactor 134. In the embodiment depicted in FIG. 2, the upper port 128 includes an inner passage 142 configured to carry the lean solvent input stream 106 to the center of the spiral rotating contactor 134 and outer annular space 140 surrounding the inner passage 142 that is configured to remove the gas discharge stream 108 from the rotating bed absorber 104. In other embodiments, the lean solvent input stream 106 and gas discharge stream 108 are carried through separate conduits connected to the rotating bed absorber 104.

Turning to FIG. 3, shown therein is a top cross-sectional view of an embodiment of the rotating bed absorber 104. The spiral rotating contactor 134 includes one or more spiral flights 144 that extend outward from a perforated central hub 146 that is connected to, or otherwise in fluid communication with, the inner passage 142 of the upper port 128. In some embodiments, the spiral flights 144 can approximate an Archimedes spiral, a Golden spiral, or a Fibonacci spiral. The central hub 146 or another portion of the spiral rotating contactor 134 is connected to the shaft 136 and configured to rotate with the shaft 136. In the embodiment depicted in FIGS. 2 and 3, the spiral rotating contactor 134 is configured to rotation in a clockwise direction when viewed from the top of the spiral rotating contactor 134.

During use, the lean absorbent is passed into the perforated central hub 146, discharged through distribution ports 158 in the central hub 146, and carried outward under centrifugal force within channels 160 between adjacent spiral flights 144. As illustrated in FIG. 5, the central hub 146 can include a plurality of discharge ports 158 that decrease in size from larger holes to smaller holes across the length of the central hub 146 to better distribute the lean solvent input stream 106. In other embodiments, the distribution holes 158 are the same size. In yet other embodiments, the distribution holes 158 at the top of the hub 146 are smaller than the distribution holes 158 at the bottom of the hub 146.

At the same time, the feed stream 102 is forced into the tank 126 and carried in a countercurrent flow against the movement of the liquid absorbent to the area surrounding the central hub 146, where the gas is evacuated through the outer annular space 140 of the upper port 128. When the loaded solvent exits the spiral flights 144, it is captured within the tank 126 and collected for discharge through the lower discharge port 130 as the rich absorbent discharge stream 110. In this way, the spiral rotating contactor 134 provides a very compact system for ensuring good contact and mixing in a countercurrent manner between the lean solvent liquid and the carbon-containing feed gas.

To improve the proper movement of the solvent through the spiral rotating contactor 134 and the mixing between the carbon-containing gas and the liquid absorbent, the spiral flights 144 can be constructed form a multi-layer mesh, as depicted in FIG. 4. The outer layers 148 can be completely or partially liquid-impermeable, while the inner layers 150 can be constructed from one or more layers of mesh that provide a frictional interface to encourage the movement of the liquid solvent outward as the spiral rotating contactor 134 rotates. In some embodiments, the outer layers 148 are constructed from a PTFE plastic or from a variety of semipermeable materials and the inner layers 150 are constructed from a suitable stainless steel or other corrosion-resistant metal or alloy. In some embodiments, the mesh inner layers 150 extend partially between adjacent outer layers 150. In some embodiments, the spiral rotating contactor 134 includes spaces or voids between the mesh inner layers 150 and the adjacent outer layers 148. In other embodiments, the mesh inner layers 150 extend completely between adjacent outer layers 148. In some embodiments, the mesh inner layers 150 extend both partially and completely between adjacent outer layers 148, depending on the position along the one or more continuous spiral flights 144.

Turning to FIG. 5, shown therein is an alternate embodiment of the rotating bed absorber 104 in which the spiral rotating contactor 134 is rotated on a substantially horizontal shaft 136 and partially submerged in a volume of absorbent within the tank 126. The feed stream 102 is carried into the tank 126 through a gas inlet 154 and the lean solvent input stream 106 is injected through an absorbent inlet 152. In some applications, the gas inlet 154 can be configured to inject the feed stream 102 through the bottom of the tank 126 such that the gas is forced to bubble through the volume of liquid absorbent in the tank 126.

In this embodiment, the rotational direction of the spiral rotating contactor 134 is reversed such that the open leading edge of the spiral flights 144 captures alternating volumes of gas and solvent with each successive rotation. In a periodic peristaltic or screw-type pumping mechanism, the spiral rotating contactor 134 captures the liquid absorbent and carbon-containing gas and mixes the gas and liquid as they are carried together inward to the central hub 146. The carbon-reduced gas and the loaded liquid absorbent can be removed from the rotating bed absorber 104 through a discharge line 156 connected to the central hub 146 and passed to a separator module 162 to allow the gas and liquid components to separate by gravity. The carbon-reduced gas can be vented or routed for downstream processing, while the loaded liquid absorbent can be routed through to the regeneration module 118, as described in FIG. 1.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention. In particular, it will be noted that the novel rotating bed absorber 104 and spiral rotating contactor 134 can be configured for use in a variety of carbon capture systems 100 beyond those disclosed herein.

It is claimed:

1. A carbon capture system configured to remove carbon dioxide from a carbon-containing feed stream, the carbon capture system comprising:
a rotating bed absorber, wherein the rotating bed absorber comprises:
a tank that includes a liquid absorbent; and a spiral rotating contactor (134)-inside the tank; and a regeneration module.

2. The carbon capture system of claim 1, wherein the spiral rotating contactor comprises a plurality of mesh layers arranged in one or more spiral flights.

3. The carbon capture system of claim 2, wherein the spiral rotating contactor comprises a continuous channel between each the one or more spiral flights.

4. The carbon capture system of claim 1, wherein the spiral rotating contactor comprises:
one or more outer layers that are liquid impermeable; and one or more inner layers that are each constructed from a mesh material.

5. The carbon capture system of claim 1, wherein the spiral rotating contactor comprises a central hub that includes a plurality of discharge ports.

6. The carbon capture system of claim 1, wherein the spiral rotating contactor is configured to rotate on a substantially vertical axis.

7. The carbon capture system of claim 6, wherein the spiral rotating contactor is immersed in the liquid absorbent inside the tank.

8. The carbon capture system of claim 1, wherein the spiral rotating contactor is configured to rotate on a substantially horizontal axis.

9. The carbon capture system of claim 8, wherein the spiral rotating contactor is partially immersed in the liquid absorbent inside the tank.

10. The carbon capture system of claim 9, wherein the spiral rotating contactor is configured as a periodic peristaltic pump that captures and mixes alternating volumes of the carbon-containing feed stream and the liquid absorbent from the tank and removes the mixed carbon-containing feed stream and liquid absorbent from the tank.

11. The carbon capture system of claim 10, wherein the carbon capture system further comprises a separation module connected to the tank and configured to separate liquid and gas components in the mixed carbon-containing feed stream removed from the tank by the spiral rotating contactor.

12. The carbon capture system of claim 1, wherein the liquid absorbent is selected from the group consisting of monoethanolamine (MEA), diethanolamine (DEA), triethanolamine (TEA) and potash.

13. The carbon capture system of claim 1, further comprising a heat exchanger between the rotating bed absorber and the regeneration module.

14. The carbon capture system of claim 1, wherein the rotating bed absorber further comprises an upper port with a coaxially positioned inner passage and an annular space surrounding the inner passage, wherein the inner passage is connected to a lean solvent input stream and the annular space permits the removal of a gas discharge stream from the rotating bed absorber.

15. The carbon capture system of claim 1, wherein the spiral rotating contactor comprises one or more spiral flights that are each approximately configured as an Archimedes spiral, a Golden spiral, or a Fibonacci spiral.
